(19) United States
(12) Patent Application Publication
(10) Pub. No.: US 2018/0172893 A1
(43) Pub. Date: Jun. 21, 2018

(54) POLYCHROMATIC GRATING-COUPLED BACKLIGHTING

(71) Applicant: LEIA INC., Menlo Park, CA (US)

(72) Inventors: David A. Fattal, Mountain View, CA (US); Ming Ma, Palo Alto, CA (US)

(21) Appl. No.: 15/898,621

(22) Filed: Feb. 18, 2018

Related U.S. Application Data
(63) Continuation of application No. PCT/US2016/019972, filed on Feb. 26, 2016.
(60) Provisional application No. 62/214,974, filed on Sep. 5, 2015.

(51) Int. Cl. F21V 8/00

(52) U.S. Cl. CPC G02B 6/0016; G02F 1/133621; G02B 6/0035

(57) ABSTRACT

Polychromatic backlighting employs a grating coupler to diffractively split and redirect collimated light coupled into a light guide. A polychromatic grating-coupled backlight includes a light guide configured to guide light and a light source to provide collimated polychromatic light. The polychromatic grating-coupled backlight further includes the grating coupler diffractively split and redirect to provide a plurality of light beams. Each light beam of the plurality represents a respective different color of the polychromatic light and is configured to propagate within the light guide as guided light at a color-specific, non-zero propagation angle corresponding to the respective different color of polychromatic light. An electronic display includes the polychromatic grating-coupled backlight and further includes a diffraction grating to diffractively couple out a portion of the guided light and a light valve array to modulate the coupled-out light as an electronic display pixel.

### CROSS-REFERENCE TO RELATED APPLICATIONS

This application is a continuation patent application of and claims the benefit of priority to International Application No. PCT/US2016/019972, filed Feb. 26, 2016, which claims priority from U.S. Provisional Patent Application Ser. No. 62/214,974, filed Sep. 5, 2015, the entire contents of both are incorporated herein by reference.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Among the most commonly found electronic displays are the cathode ray tube (CRT), plasma display panels (PDP), liquid crystal displays (LCD), electroluminescent displays (EL), organic light-emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). In general, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

To overcome the limitations of passive displays associated with emitted light, many passive displays are coupled to an external source of light. The coupled source of light may allow these otherwise passive displays to emit light and function substantially as an active display. Examples of such coupled sources of light are backlights. Backlights are sources of light (often panels) that are placed behind an otherwise passive display to illuminate the passive display. For example, a backlight may be coupled to an LCD or an EP display. The backlight emits light that passes through the LCD or the EP display. The light emitted is modulated by the LCD or the EP display and the modulated light is then emitted, in turn, from the LCD or the EP display. Often backlights are configured to emit white light. Color filters are then used to transform the white light into various colors used in the display. The color filters may be placed at an output of the LCD or the EP display (less common) or between the backlight and the LCD or the EP display, for example.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates a graphical view of angular components {θ, ϕ} of a light beam having a particular principal angular direction, according to an example of the principles describe herein.

FIG. 2A illustrates a cross sectional view of a polychromatic grating-coupled backlight, according to an embodiment consistent with the principles described herein.

FIG. 2B illustrates a cross sectional view of a polychromatic grating-coupled backlight, according to another embodiment consistent with the principles described herein.

FIG. 2C illustrates an expanded cross sectional view of an input end portion of a polychromatic grating-coupled backlight of FIG. 2B, in an embodiment consistent with the principals described herein.

FIG. 3A illustrates a side view of a light source having a plurality of different color optical emitters in an example, according to an embodiment consistent with the principal described herein.

FIG. 3B illustrates a side view of a light source having a plurality of different color optical emitters in an example, according to another embodiment consistent with the principal described herein.

FIG. 4A illustrates a cross sectional view of an input end portion of a polychromatic grating-coupled backlight in an example, according to an embodiment consistent with the principles described herein.

FIG. 4B illustrates a cross sectional view of an input end portion of a polychromatic grating-coupled backlight in an example, according to another embodiment consistent with the principles described herein.

FIG. 5A illustrates a cross sectional view of an input end portion of a polychromatic grating-coupled backlight in an example, according to another embodiment consistent with the principles described herein.

FIG. 5B illustrates a cross sectional view of an input end portion of a polychromatic grating-coupled backlight in an example, according to yet another embodiment consistent with the principles described herein.

FIG. 6A illustrates a cross sectional view of a portion of a polychromatic grating-coupled backlight including a multibeam diffraction grating in an example, according to an embodiment consistent with the principles described herein.

FIG. 6B illustrates a perspective view of the polychromatic grating-coupled backlight portion of FIG. 6A including the multibeam diffraction grating in an example, according to an embodiment consistent with the principles described herein.

FIG. 7 illustrates a block diagram of an electronic display in an example, according to an embodiment consistent with the principles described herein.

FIG. 8 illustrates a flow chart of a method of polychromatic grating-coupled backlight operation in an example, according to an embodiment consistent with the principles described herein.

Certain examples and embodiments may have other features that are one of in addition to and in lieu of the features illustrated in the above-referenced figures. These and other features are detailed below with reference to the above-referenced figures.

### DETAILED DESCRIPTION

Embodiments in accordance with the principles described herein provide polychromatic backlighting. In particular, polychromatic backlighting of electronic displays and specifically of multiview or three-dimensional (3D) displays may be provided. According to various embodiments, a grating coupler is configured to couple collimated polychromatic light into a light guide (e.g., a plate light guide) using a diffraction grating. The diffraction grating of the grating coupler is configured to both diffractively split and redirect the collimated polychromatic light into a plurality of light beams representing different colors of light of the collimated polychromatic light. Further, the different color light beams are redirected at and configured to propagate according to different color-specific, non-zero propagation angles within the light guide. In some embodiments, the different color-specific, non-zero propagation angles may mitigate color-dependent characteristics of the backlight including, but not limited to, a color-dependent coupling angle associated with light coupled out or otherwise emitted by the backlight.

According to various embodiments, the coupled-out light of the backlight forms a plurality of light beams that is directed in a predefined direction such as an electronic display viewing direction. Light beams of the plurality may have different principal angular directions from one another, according to various embodiments of the principles described herein. In particular, the plurality of light beams may form or provide a light field in the viewing direction. Further, the light beams may represent a plurality of different colors (e.g., different primary colors), in some embodiments. The light beams having the different principal angular directions (also referred to as ‘the differently directed light beams’) and, in some embodiments, representing a combination of different colors may be employed to display information including three-dimensional (3D) information. For example, the differently directed, different color light beams may be modulated and serve as color pixels of a ‘glasses free’ 3D or multiview color electronic display.

Herein, a ‘light guide’ is defined as a structure that guides light within the structure using total internal reflection. In particular, the light guide may include a core that is substantially transparent at an operational wavelength of the light guide. In various embodiments, the term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piece-wise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, a plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to insure that total internal reflection is maintained within the plate light guide to guide light.

Herein, a ‘diffraction grating’ and more specifically a ‘multibeam diffraction grating’ is generally defined as a plurality of features (i.e., diffractive features) arranged to provide diffraction of light incident on the diffraction grating. In some examples, the plurality of features may be arranged in a periodic or quasi-periodic manner. For example, the plurality of features (e.g., a plurality of grooves in a material surface) of the diffraction grating may be arranged in a one-dimensional (1D) array. In other examples, the diffraction grating may be a two-dimensional (2D) array of features. The diffraction grating may be a 2D array of bumps on or holes in a material surface, for example.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating (i.e., diffracted light) generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in and on a surface (i.e., wherein a ‘surface’ refers to a boundary between two materials). The surface may be a surface of a plate light guide. The diffractive features may include any of a variety of structures that diffract light including, but not limited to, one or more of grooves, ridges, holes and bumps, and these structures may be one or more of at, in and on the surface. For example, the diffraction grating may include a plurality of parallel grooves in a material surface. In another example, the diffraction grating may include a plurality of parallel ridges rising out of the material surface. The diffractive features (whether grooves, ridges, holes, bumps, etc.) may have any of a variety of cross sectional shapes or profiles that provide diffraction including, but not limited to, one or more of a sinusoidal profile, a rectangular profile (e.g., a binary diffraction grating), a triangular profile and a saw tooth profile (e.g., a blazed grating).

By definition herein, a ‘multibeam diffraction grating’ is a diffraction grating that produces coupled-out light that includes a plurality of light beams. Further, the light beams of the plurality produced by a multibeam diffraction grating have different principal angular directions from one another, by definition herein. In particular, by definition, a light beam of the plurality has a predetermined principal angular direction that is different from another light beam of the light beam plurality as a result of diffractive coupling and diffractive redirection of incident light by the multibeam diffraction grating. The light beam plurality may represent a light field. For example, the light beam plurality may include eight light beams that have eight different principal angular directions. The eight light beams in combination (i.e., the light beam plurality) may represent the light field, for example. According to various embodiments, the different principal angular directions of the various light beams are determined by a combination of a grating pitch or spacing and an orientation or rotation of the diffractive features of the multibeam diffraction grating at points of origin of the respective light beams relative to a propagation direction of the light incident on the multibeam diffraction grating.

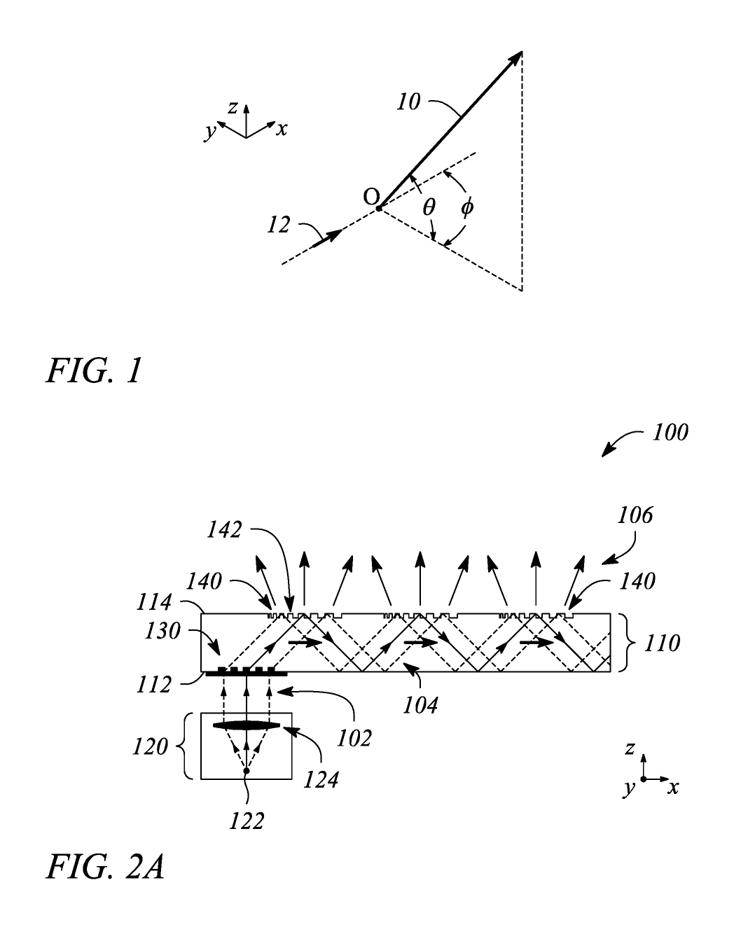

In particular, a light beam produced by the multibeam diffraction grating has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multibeam diffraction grating) while the azimuth angle ϕ is an angle in a horizontal plane (e.g., parallel to the multibeam diffraction grating plane). FIG. 1 illustrates the angular components {θ, ϕ} of a light beam 10 having a particular principal angular direction, according to an example of the principles describe herein. In addition, the light beam 10 is emitted or emanates from a particular point, by definition herein. That is, by definition, the light beam 10 has a central ray associated with a particular point of origin within the multibeam diffraction grating. FIG. 1 also illustrates the light beam point of origin O. An example propagation direction of incident light is illustrated in FIG. 1 using a bold arrow 12 directed toward the point of origin O.

According to various embodiments described herein, the light coupled out of the light guide by the diffraction grating (e.g., a multibeam diffraction grating) represents a pixel of an electronic display. In particular, the light guide having a multibeam diffraction grating to produce the light beams of the plurality having different principal angular directions may be part of a backlight of or used in conjunction with an electronic display such as, but not limited to, a ‘glasses free’ three-dimensional (3D) electronic display (also referred to as a multiview or ‘holographic’ electronic display or an autostereoscopic display). As such, the differently directed light beams produced by coupling out guided light from the light guide using the multibeam diffractive grating may be or represent ‘pixels’ of the 3D electronic display. Moreover, as described above, the differently directed light beams may form a light field.

Herein a ‘collimator’ is defined as substantially any optical device or apparatus that is configured to collimate light. For example, a collimator may include, but is not limited to, a collimating mirror or reflector, a collimating lens, and various combinations thereof. In some embodiments, the collimator comprising a collimating reflector may have a reflecting surface characterized by a parabolic curve or shape. In another example, the collimating reflector may comprise a shaped parabolic reflector. By ‘shaped parabolic’ it is meant that a curved reflecting surface of the shaped parabolic reflector deviates from a ‘true’ parabolic curve in a manner determined to achieve a predetermined reflection characteristic (e.g., a degree of collimation). Similarly, a collimating lens may comprise a spherically shaped surface (e.g., a biconvex spherical lens).

In some embodiments, the collimator may be a continuous reflector or a continuous lens (i.e., a reflector or a lens having a substantially smooth, continuous surface). In other embodiments, the collimating reflector or the collimating lens may comprise a substantially discontinuous surface such as, but not limited to, a Fresnel reflector or a Fresnel lens that provides light collimation. According to various embodiments, an amount of collimation provided by the collimator may vary in a predetermined degree or amount from one embodiment to another. Further, the collimator may be configured to provide collimation in one or both of two orthogonal directions (e.g., a vertical direction and a horizontal direction). That is, the collimator may include a shape in one or both of two orthogonal directions that provides light collimation, according to some embodiments.

Herein, a ‘light source’ is defined as a source of light (e.g., an apparatus or device that emits light). For example, the light source may be a light emitting diode (LED) that emits light when activated. The light source may be substantially any source of light or optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by a light source may have a color or may include a particular wavelength of light. Moreover, a ‘polychromatic light source’ is a light source configured to provide at least two different colors or wavelengths of emitted light. As such, a ‘plurality of light sources of different colors’ of a polychromatic light source is explicitly defined herein as a set or group of light sources in which at least one of the light sources produces light having a color, or equivalently a wavelength, that differs from a color or wavelength of light produced by at least one other light source of the set or group of light source plurality. Moreover, the ‘plurality of light sources of different colors’ may include more than one light source of the same or substantially similar color as long as at least two light sources of the plurality of light sources are different color light sources (i.e., at least two light sources produce colors of light that are different). Hence, by definition herein, a ‘plurality of light sources of different colors’ may include a first light source that produces a first color of light and a second light source that produces a second color of light, where the second color differs from the first color. In addition, by definition herein, a ‘white’ light source is a polychromatic light source since white light comprises a plurality of different colors (e.g., red, green and blue) that in combination appear as white light.

Further, as used herein, the article ‘a’ is intended to have its ordinary meaning in the patent arts, namely ‘one or more’. For example, ‘a grating’ means one or more gratings and as such, ‘the grating’ means ‘the grating(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

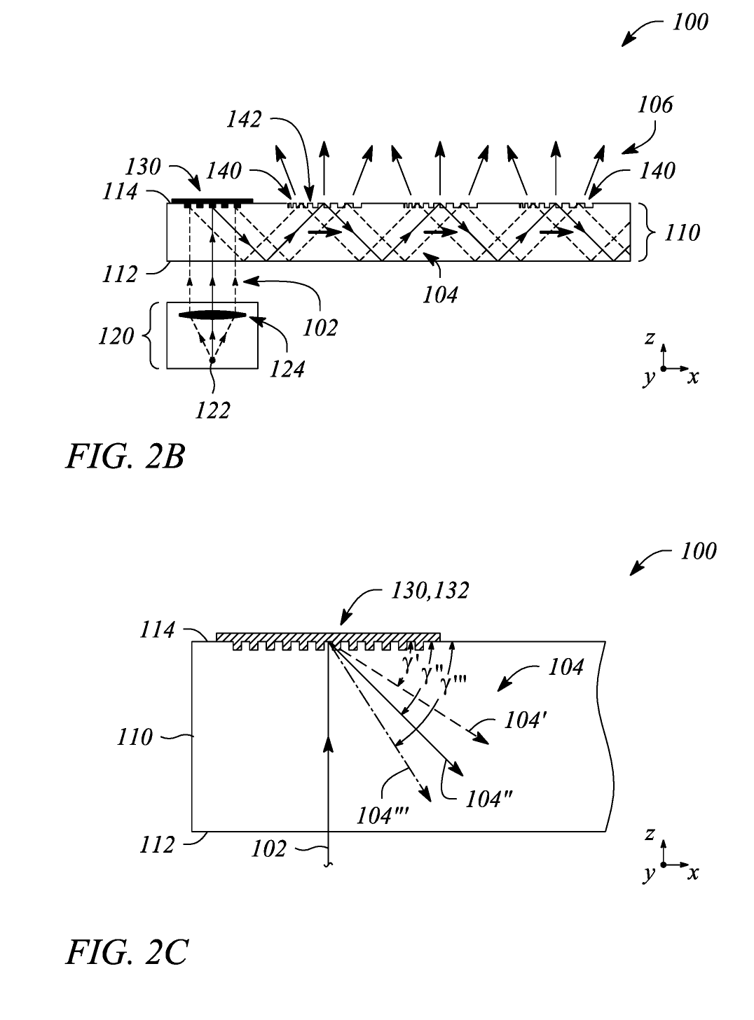

In accordance with some embodiments of the principles described herein, a polychromatic grating-coupled backlight is provided. FIG. 2A illustrates a cross sectional view of a polychromatic grating-coupled backlight 100, according to an embodiment consistent with the principles described herein. FIG. 2B illustrates a cross sectional view of a polychromatic grating-coupled backlight 100, according to another embodiment consistent with the principles described herein. FIG. 2C illustrates an expanded cross sectional view of an input end portion of the polychromatic grating-coupled backlight 100 of FIG. 2B, in an embodiment consistent with the principals described herein. The polychromatic grating-coupled backlight 100 is configured to couple polychromatic light 102 into the polychromatic grating-coupled backlight 100 as guided light 104. Moreover, the polychromatic light 102, when coupled in, is split into a plurality of different color light beams, wherein the different color light beams are configured to propagate as the guided light 104 at respective different color-specific, non-zero propagation angles, according to various embodiments.

As illustrated in FIGS. 2A-2B, the polychromatic grating-coupled backlight 100 comprises a plate light guide 110 configured to guide light as the guided light 104, according to various embodiments. The guided light 104 may be guided along a length or extent of the plate light guide 110 from an input end to a terminal end as illustrated by bold arrows. Further, the plate light guide 110 is configured to guide light (i.e., guided light 104) at respective ones of the different color-specific, non-zero propagation angles, according to various examples.

In some embodiments, the plate light guide 110 is a slab or plate optical waveguide comprising an extended, substantially planar sheet of optically transparent, dielectric material. The substantially planar sheet of dielectric material is configured to guide the guided light 104 using total internal reflection. According to various embodiments, the optically transparent material of the plate light guide 110 may comprise any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the plate light guide 110 may further include a cladding layer on at least a portion of a surface (e.g., one or both of the top surface and the bottom surface) of the plate light guide 110 (not illustrated). The cladding layer may be used to further facilitate total internal reflection, according to some embodiments.

As defined herein, a ‘color-specific, non-zero propagation angle’ is an angle relative to a surface (e.g., a top surface or a bottom surface) of the plate light guide 110. As provided above, the plate light guide 110 may include a dielectric material configured as an optical waveguide. The guided light 104 may propagate by reflecting or ‘bouncing’ between the top surface and the bottom surface of the plate light guide 110 at the non-zero propagation angle (e.g., illustrated by an extended, angled arrow outlined by dashed lines representing a light ray of the guided light 104). The guided light 104 propagates along the plate light guide 110 in the first direction that is generally away from an input end (e.g., illustrated by the bold arrows pointing along an x-axis in FIGS. 2A-2B).

According to various embodiments, the color specific, non-zero propagation angles of the guided light 104 beam may be between about ten (10) degrees and about fifty (50) degrees or, in some examples, between about twenty (20) degrees and about forty (40) degrees, or between about twenty-five (25) degrees and about thirty-five (35) degrees. For example, the color-specific, non-zero propagation angle may be about thirty (30) degrees. In other examples, the non-zero propagation angles may be about 20 degrees, or about 25 degrees, or about 35 degrees.

The guided light 104 produced by coupling the polychromatic light 102 into the plate light guide 110 may be collimated (e.g., may be a collimated guided light ‘beam’) within the plate light guide 110, according to some embodiments. Further, according to some embodiments, the guided light 104 may be collimated in one or both of a plane that is perpendicular to a plane of a surface of the plate light guide 110 and in a plane parallel to the surface. For example, the plate light guide 110 may be oriented in a horizontal plane having a top surface and a bottom surface parallel to an x-y plane (e.g., as illustrated). The guided light 104 may be collimated or substantially collimated in a vertical plane (e.g., an x-z plane), for example. In some embodiments, the guided light 104 may also be collimated or substantially collimated in a horizontal direction (e.g., in the x-y plane).

Herein, a ‘collimated light’ or ‘collimated light beam’ is defined as a beam of light in which rays of the light beam are substantially parallel to one another within the light beam (e.g., a beam of the guided light 104). Further, rays of light that diverge or are scattered from the collimated light beam are not considered to be part of the collimated light beam, by definition herein. According to some embodiments, collimation of the light to produce the collimated guided light 104 (or a guided light beam) may be provided by a lens or a mirror (e.g., tilted collimating reflector, etc.) of a light source used to provide the polychromatic light 102, e.g., the light source 120, described below.

As illustrated in FIGS. 2A-2B, the polychromatic grating-coupled backlight 100 further comprises a light source 120. The light source 120 comprises an optical emitter 122 and a collimator 124, according to various embodiments. The optical emitter 122 is configured to provide polychromatic light, and the collimator 124 is configured to collimate the polychromatic light provided by the optical emitter 122. The collimated polychromatic light at the output of the collimator 124 may correspond to the polychromatic light 102, as illustrated. In particular, the polychromatic light 102 is collimated polychromatic light 102, according to various embodiments. Note that, while described and illustrated herein as separate elements or functions, in some embodiments of the light source 120, the optical emitter 122 and the collimator 124 may be combined or substantially inseparable, e.g., as when the light source 120 comprises a laser which is configured to both be the optical emitter 122 and provide collimation of emitted light.

In some embodiments, the optical emitter 122 comprises a white light source (i.e., a light source configured to provide substantially ‘white’ light) or a similar light source configured to produce polychromatic light having a relatively broad optical bandwidth or spectrum, e.g., a bandwidth greater than about 10 nanometers. For example, the white light source may comprise a light emitting diode (LED) configured to provide white light (e.g., a so-called ‘white’ LED). A variety of other white light sources may be used including, but not limited to, a fluorescent lamp or a fluorescent tube. In particular, the optical emitter 122 may be a single optical emitter configured to produce a plurality of different colors of light mixed together (e.g., as white light) to provide the polychromatic light 102 of the light source 120. In other embodiments, the optical emitter 122 may comprise a plurality of optical emitters of different colors, wherein the optical emissions of which may be combined to provide the polychromatic light 102.

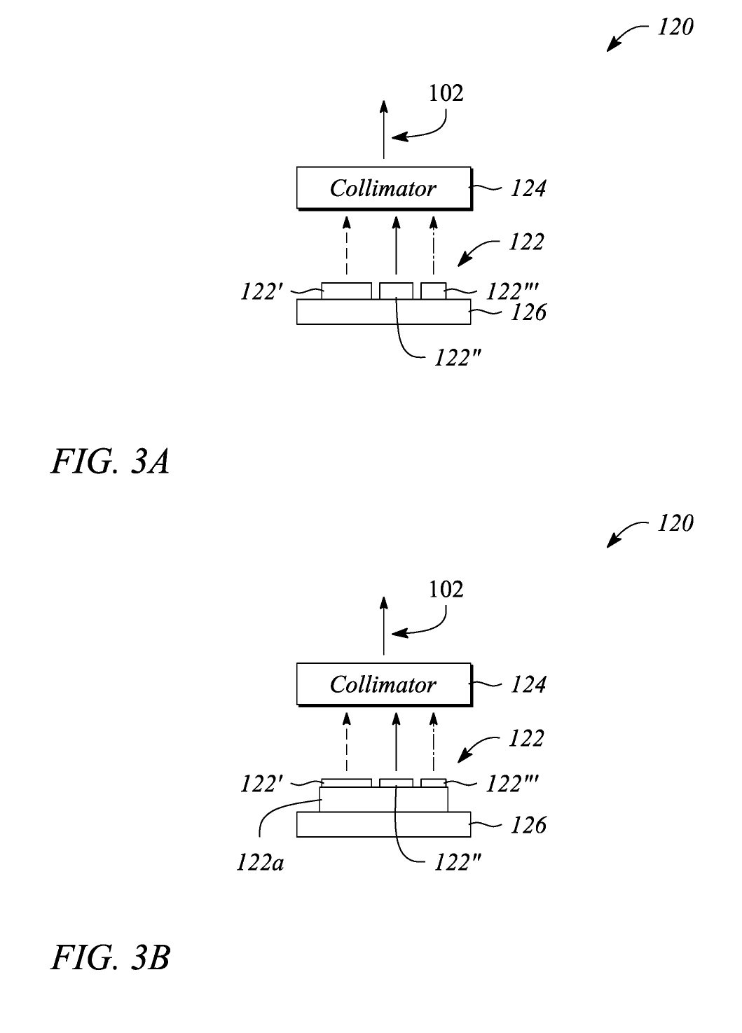

FIG. 3A illustrates a side view of a light source 120 having a plurality of different color optical emitters 122 in an example, according to an embodiment consistent with the principal described herein. In particular, as illustrated in FIG. 3A, the light source 120 comprises a first optical emitter 122′ configured to provide substantially red light, a second optical emitter 122′″ configured to provide substantially green light, and a third optical emitter 122′″ configured to provide substantially blue light. For example, the first optical emitter 122′ may comprise a light emitting diode (LED) configured to produce red light (i.e., a red LED), the second optical emitter 122″ may comprise an LED configured to provide green light (i.e., a green LED), and the third optical emitter 122′″ may comprise an LED configured to provide blue light (i.e., a blue LED). The optical emitters 122′, 122″, 122′″ are illustrated in FIG. 3A as being mounted on a substrate 126, by way of example and not limitation.

FIG. 3B illustrates a side view of a light source 120 having a plurality of different color optical emitters 122 in an example, according to another embodiment consistent with the principal described herein. In particular, the light source 120 illustrated in FIG. 3B comprises an illumination source 122a and a plurality of phosphors serving as the optical emitters 122′, 122″, 122′″. The illumination source 122a is configured to provide illumination and the plurality of phosphors is configured to luminesce in response to the illumination from the illumination source 122a. FIG. 3B illustrates the illumination source 122a mounted on a substrate 126 and the plurality of phosphors serving as the optical emitters 122′, 122″, 122′″ affixed to a surface of the illumination source 122a, by way of example and not limitation.

According to some embodiments, the illumination source 122a may comprise a blue light source (e.g., a blue LED). In other embodiments, another color light source may be employed as the illumination source 122a. In yet other embodiments, the illumination source 122a may comprise an ultraviolet (UV) light source.

According to various embodiments, each phosphor of the plurality of phosphors has a luminescence corresponding to a different color of the polychromatic light 102. For example, when illuminated by the illumination source 122a, a first phosphor serving as a first optical emitter 122′ may have a luminescence configured to provide red light, a second phosphor serving as a second optical emitter 122″ may have a luminescence configured to provide green light, and a third phosphor serving as a third optical emitter 122′″ may have a luminescence configured to provide blue light. As such, each of the phosphors in combination with the illumination source 122a may be substantially similar the plurality of different color optical emitters 122′, 122″, 122′″, described above.

Further, when a plurality of optical emitters 122 of different colors is employed (e.g., different color LEDs or different color phosphors, etc.), a relative size, or equivalently, an optical output strength or intensity, of the different color optical emitters 122 may be selected to adjust a spectrum of the polychromatic light 102 in some embodiments. For example, the first optical emitter 122′ (e.g., a red LED) may be larger than the second optical emitter 122″ (e.g., a green LED) to provide a relatively greater amount of red light than green light in the polychromatic light 102 spectrum. In turn, the second optical emitter 122″ (e.g., the green LED) may be larger than the third optical emitter 122′″ (e.g., a blue LED) of the plurality of optical emitters 122 to provide more green light relative to blue light in the polychromatic light 102 spectrum. Note, the ‘relative size’ of an optical emitter 122 of a particular color may be provided by an actual physical size or by combining a plurality of similar optical emitters to serve as the optical emitter 122, for example.

As such, when a plurality of optical emitters 122 is employed, the mix or spectral content of light of different colors in the polychromatic light 102 may be adjusted or tailored to a particular application. For example, in the polychromatic grating-coupled backlight 100, blue light may be used more efficiently than green light, while use of green light may be more efficient than red light, in some embodiments. By ‘used more efficiently’ it is meant that light of some colors may be emitted by or otherwise employed at a higher rate or with less loss, etc., within the polychromatic grating-coupled backlight 100 than other colors.

According to some embodiments, the relative size of the first or ‘red’ optical emitter 122′ in relation to the second or ‘green’ optical emitter 122″ may be increased (e.g., as illustrated in FIG. 3A) to compensate for or substantially mitigate differential usage efficiencies of red and green light by the polychromatic grating-coupled backlight 100. Similarly, differential usage efficiencies of blue light relative to green light in the polychromatic grating-coupled backlight 100 may be compensated for or substantially mitigated by a decreased relative size of the third or ‘blue’ optical emitter 122′″ in relation to the second or ‘green’ optical emitter 122″, according to some embodiments. FIG. 3A illustrates relative size differences of the first, second and third optical emitters 122′, 122″, 122′″ configured to mitigate color-dependent, differential usage efficiencies, by way of example and not limitation.

Also illustrated in FIGS. 3A and 3B is the collimator 124. According to various embodiments, the collimator 124 may be substantially any collimator. For example, the collimator 124 of the light source 120 may comprise a lens and, in particular, a collimating lens. A simple, convex lens may be employed as a collimating lens, for example. FIGS. 2A-2B illustrate a collimator 124 of the light source 120 comprising a collimating lens. In other examples, the collimator 124 may comprise another collimating device or apparatus including, but not limited to, a collimating reflector (e.g., a parabolic or shaped parabolic reflector), a plurality of collimating lenses and reflectors, and a diffraction grating configured to collimate light. The different colors of light from the plurality of optical emitters 122 or white light of the white light source (i.e., comprising a plurality of optical emitters 122 of different colors) may enter the collimator 124 as substantially uncollimated light and exit as collimated polychromatic light 102. For example, the different colors of light provide by the first, second and third optical emitters 122′, 122″, 122′″ described above may be ‘mixed’ together and also collimated by the collimator 124 to provide the collimated polychromatic light 102.

Referring again to FIGS. 2A-2C, the polychromatic grating-coupled backlight 100 further comprises a grating coupler 130. The grating coupler 130 is configured to diffractively split and redirect the collimated polychromatic light 102 into a plurality of light beams. Each light beam of the plurality represents a respective different color of the polychromatic light 102. Further, each light beam is configured to propagate within the plate light guide 110 as the guided light 104 at a color-specific, non-zero propagation angle corresponding to the respective different color of polychromatic light. In particular, the collimated polychromatic light 102 is split into the different colors and also redirected into the plate light guide 110 at the respective different color-specific, non-zero propagation angles according to diffraction provided by the grating coupler 130. For example, the polychromatic light 102 may comprise a different two or more of red light, green light and blue light. Upon splitting and redirection by the grating coupler 130, the corresponding color-specific, non-zero propagation angle of guided light 104 (or a light beam thereof) with a longer wavelength may be smaller than the corresponding color-specific, non-zero propagation angle of light with a shorter wavelength.

In FIG. 2C, three extended arrows labeled 104′, 104″, and 104′″ represents three different color light beams of the guided light 104 that have three different color-specific, non-zero propagation angles γ′, γ″, γ′″, respectively, following diffractive splitting and diffractive redirection by the grating coupler 130. A first arrow, or equivalently a first light beam 104′, may represent red light propagating at the color-specific, non-zero propagation angle γ′ corresponding to red light. A second arrow, or equivalently a second light beam 104″, may represent green light propagating at the color-specific, non-zero propagation angle γ″ corresponding to green light. Similarly, blue light may be represented by a third arrow, or equivalently a third light beam 104′″, propagating at the color-specific, non-zero propagation angle γ′″ corresponding to the blue light. In FIGS. 2A and 2B (and elsewhere herein) only a central light beam of the guided light 104 may be illustrated for ease of illustration with an understanding that the central light beam generally represents a plurality of light beams (e.g., light beams 104′, 104″, and 104′″) having respective different color-specific, non-zero propagation angles (e.g., the angles γ′, γ″, γ′″, illustrated in FIG. 2C).

According to various embodiments, the grating coupler 130 comprises a diffraction grating 132 (e.g., illustrated in FIG. 2C) having diffractive features (e.g., grooves or ridges) that are spaced apart from one another to provide diffraction of incident light. In some embodiments, the diffractive features may be variously at, in or adjacent to a surface of the plate light guide 110. According to some embodiments, a spacing between the diffractive features of the diffraction grating 132 is uniform or at least substantially uniform (i.e., the diffraction grating 132 is a uniform diffraction grating). In other embodiments, a diffraction grating 132 having a chirp (e.g., a slight or relatively minor chirp) may be employed. In yet other embodiments, a complex or multi-period diffraction grating may be used as the diffraction grating 132.

According to various embodiments, the diffraction grating 132 may produce a plurality of diffraction products including, but not limited to, a zero order product, a first order product and so on. A first order product may be used in diffractive splitting and redirection, according to some embodiments. Further, a zero order diffraction product of the diffraction grating 132 may be suppressed, according to various embodiments. For example, the diffraction grating may have a diffractive feature height or depth (e.g., ridge height or groove depth) and a duty cycle selectively chosen to suppress the zero order diffraction product. In some embodiments, the duty cycle of the diffraction grating 132 (i.e., of the diffractive features) may be between about thirty percent (30%) and about seventy percent (70%). Further, in some embodiments, the diffractive feature height or depth may range from greater than zero to about five hundred nanometers (500 nm). For example, the duty cycle may be about fifty percent (50%) and the diffractive feature height or depth may be about one hundred forty nanometers (140 nm).

In some embodiments, the grating coupler 130 may be a transmissive grating coupler comprising a diffraction grating 132 that is a transmission mode diffraction grating. In other embodiments, the grating coupler 130 may be a reflective grating coupler comprising a diffraction grating 132 that is a reflection mode diffraction grating. In yet other embodiments, the grating coupler 130 comprises both a transmission mode diffraction grating and a reflection mode diffraction grating.

In particular, the grating coupler 130 may comprise a transmission mode diffraction grating at a first (e.g., an input) surface 112 of the plate light guide 110 adjacent to the light source 120, e.g., as illustrated in FIG. 2A. The transmission mode diffraction grating is configured to diffractively split and redirect the collimated polychromatic light 102 that is transmitted or passes through transmission mode diffraction grating. Alternatively (e.g., as illustrated in FIG. 2B), the grating coupler 130 may comprise a reflection mode diffraction grating at a second surface 114 of the plate light guide 110 that is opposite to the first surface 112. For example, the light source 120 may be configured to illuminate the grating coupler 130 on the second surface 114 through a portion of the first surface 112 of the plate light guide 110. The reflection mode diffraction grating is configured to diffractively split and redirect the collimated polychromatic light 102 into the plate light guide 110 using reflective diffraction (i.e., reflection and diffraction).

According to various examples, the diffractive grating 132 of the grating coupler 130 (i.e., whether transmission mode or reflection mode) may include grooves, ridges or similar diffractive features formed or otherwise provided on or in the surface 112, 114 of the plate light guide 110. For example, grooves or ridges may be formed in or on the light source-adjacent first surface 112 of the plate light guide 110 to serve as the transmission mode diffraction grating. Alternatively, grooves or ridges may be formed or otherwise provided in or on the second surface 114 of the plate light guide 110 opposite to the light source-adjacent first surface 112 to serve as the reflection mode diffraction grating, for example.

According to some embodiments, the grating coupler 130 may include a grating material (e.g., a layer of grating material) on or in the respective plate light guide surface 112, 114. The grating material may be substantially similar to a material of the plate light guide 110, while in other examples, the grating material may differ (e.g., have a different refractive index) from the plate light guide material. For example, the diffractive grating grooves in the plate light guide surface may be filled with the grating material. In particular, grooves of the diffraction grating 132 of the grating coupler 130 that is either transmissive or reflective may be filled with a dielectric material (i.e., the grating material) that differs from a material of the plate light guide 110. The grating material of the grating coupler 130 may include silicon nitride, for example, while the plate light guide 110 may be glass, according to some examples. Other grating materials including, but not limited to, indium tin oxide (ITO) may also be used.

In other embodiments, the grating coupler 130, whether transmissive or reflective, may include ridges, bumps, or similar diffractive features that are deposited, formed or otherwise provided on the respective surface of the plate light guide 110 to serve as the particular diffraction grating 132. The ridges or similar diffractive features may be formed (e.g., by etching, molding, etc.) in a dielectric material layer (i.e., the grating material) that is deposited on the respective surface of the plate light guide 110, for example. In some examples, the grating material of the grating coupler 130 may include a reflective metal. For example, the reflection mode diffraction grating 132″ may comprise a layer of reflective metal such as, but not limited to, gold, silver, aluminum, copper and tin, to facilitate reflection in addition to diffraction.

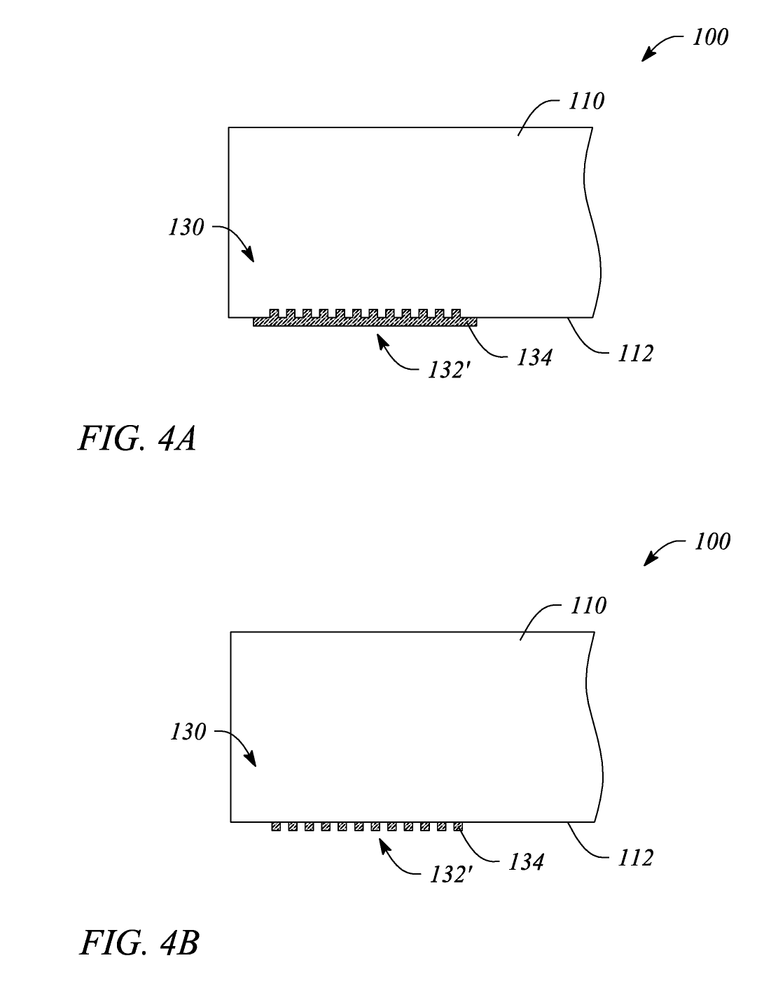

FIG. 4A illustrates a cross sectional view of an input end portion of a polychromatic grating-coupled backlight 100 in an example, according to an embodiment consistent with the principles described herein. FIG. 4B illustrates a cross sectional view of an input end portion of a polychromatic grating-coupled backlight 100 in an example, according to another embodiment consistent with the principles described herein. In particular, both FIGS. 4A and 4B may illustrate a portion of the polychromatic grating-coupled backlight 100 of FIG. 2A that includes the grating coupler 130. Further, the grating coupler 130 illustrated in FIGS. 4A-4B is a transmissive grating coupler that includes a transmission mode diffraction grating 132′.

As illustrated in FIG. 4A, the grating coupler 130 comprises grooves (i.e., diffractive features) formed in the light source-adjacent first surface 112 of the plate light guide 110 to form the transmission mode diffraction grating 132′. Further, the transmission mode diffraction grating 132′ of the grating coupler 130 illustrated in FIG. 4A includes a layer of grating material 134 (e.g., silicon nitride) that is also deposited in the grooves. FIG. 4B illustrates a grating coupler 130 comprising ridges (i.e., diffractive features) of the grating material 134 on the light source-adjacent first surface 112 of the plate light guide 110 to form the transmission mode diffraction grating 132′. Etching or molding a deposited layer of the grating material 134, for example, may produce the ridges. In some embodiments, the grating material 134 that makes up the ridges illustrated in FIG. 4B may include a material that is substantially similar to a material of the plate light guide 110. In other embodiments, the grating material 134 may differ from the material of the plate light guide 110. For example, the plate light guide 110 may include a glass or a plastic/polymer sheet and the grating material 134 may be a different material such as, but not limited to, silicon nitride, that is deposited on the plate light guide 110.

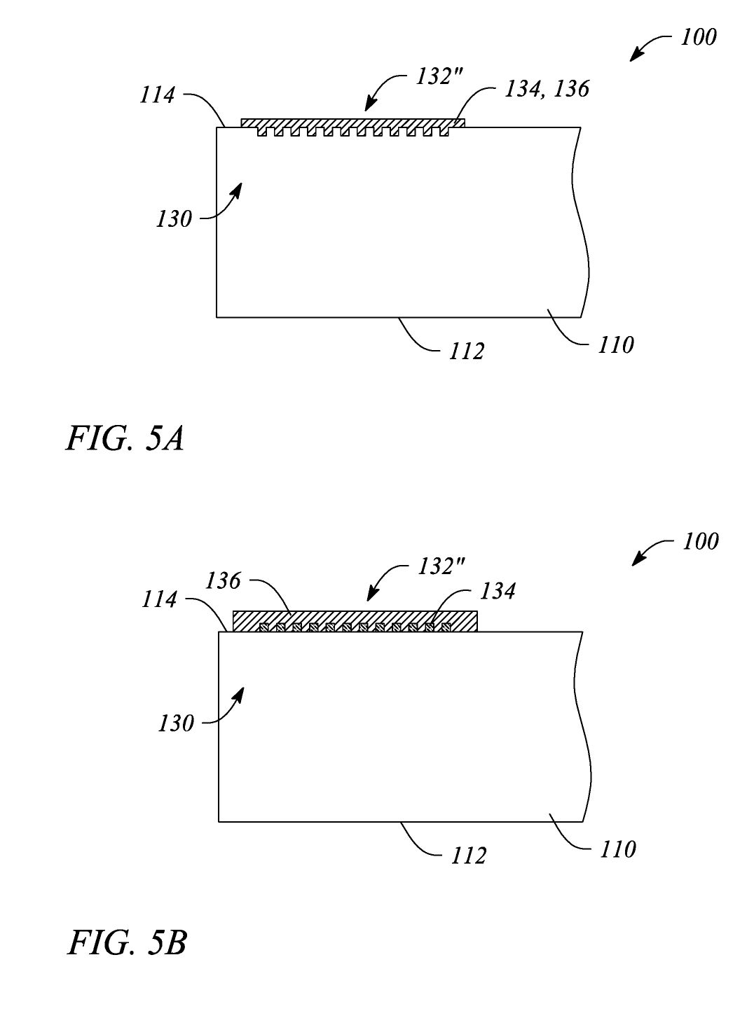

FIG. 5A illustrates a cross sectional view of an input end portion of a polychromatic grating-coupled backlight 100 in an example, according to another embodiment consistent with the principles described herein. FIG. 5B illustrates a cross sectional view of an input end portion of a polychromatic grating-coupled backlight 100 in an example, according to another embodiment consistent with the principles described herein. In particular, both FIGS. 5A and 5B illustrate a portion of the polychromatic grating-coupled backlight 100 of FIG. 2B that includes the grating coupler 130. Further, the grating coupler 130 illustrated in FIGS. 5A-5B is a reflective grating coupler that includes a reflection mode diffraction grating 132″. As illustrated therein, the grating coupler 130 (i.e., a reflection mode diffraction grating coupler) is at or on the second surface 114 of the plate light guide 110 (e.g., ‘top surface’) opposite the first surface 112 that is adjacent to the light source, e.g., light source 120 illustrated in FIG. 2B.

In FIG. 5A, the reflection mode diffraction grating 132″ of the grating coupler 130 comprises grooves (i.e., diffractive features) formed in the second surface 114 of the plate light guide 110 and a grating material 134 in the grooves. In this example, the grooves are filled with and further backed by a layer 136 of the grating material 134 that comprises a metal material to provide additional reflection and improve a diffractive efficiency of the grating coupler 130. In other words, the grating material 134 includes the metal layer 136. In other examples (not illustrated), the grooves may be filled with a grating material (e.g., silicon nitride) and then backed or substantially covered by a metal layer, for example.

FIG. 5B illustrates a grating coupler 130 that includes ridges (diffractive features) formed of the grating material 134 on the second surface 114 of the plate light guide 110 to create the reflection mode diffraction grating 132″. The ridges may be etched in a layer of silicon nitride (i.e., the grating material 134) applied to the plate light guide 110, for example. In some examples, a metal layer 136 is provided to substantially cover the ridges of the reflection mode diffraction grating 132″ to provide increased reflection and improve the diffractive efficiency, for example.

According to various embodiments, the grating coupler 130 may provide relatively high coupling efficiency. In particular, coupling efficiency of greater than about twenty percent (20%) may be achieved, according to some examples. For example, in a transmission-mode configuration (i.e., when the transmission mode diffraction grating 132′ is employed), the coupling efficiency of the grating coupler 130 may be greater than about thirty percent (30%) or even greater than about thirty-five percent (35%). A coupling efficiency of up to about forty percent (40%) may be achieved, in some embodiments. In a reflection-mode configuration (i.e., when a reflection mode grating coupler 132″ is employed), the coupling efficiency of the grating coupler 130 may be as high as about fifty percent (50%), or about sixty percent (60%) or even about seventy percent (70%), according to various embodiments.

Referring again to FIGS. 2A and 2B, the polychromatic grating-coupled backlight 100 may further comprise a diffraction grating 140. In particular, the polychromatic grating-coupled backlight 100 may comprise a plurality of diffraction gratings 140, according to some embodiments. The plurality of diffraction gratings 140 may be arranged as or represent an array of diffraction gratings 140, for example. As illustrated in FIGS. 2A-2B, the diffraction gratings 140 are located at a surface of the plate light guide 110 (e.g., a top or front surface or the second surface 114). In other examples (not illustrated), one or more of the diffraction gratings 140 may be located within the plate light guide 110. In yet other embodiments (not illustrated), one or more of the diffraction gratings 140 may be located at or on a bottom or back surface (the first surface 112) of the plate light guide 110.

The diffraction grating 140 is configured to scatter or couple out a portion of the guided light 104 from the plate light guide 110 by or using diffractive coupling (e.g., also referred to as ‘diffractive scattering’), according to various embodiments. The portion of the guided light 104 may be diffractively coupled out by the diffraction grating 140 through the light guide surface on which the diffraction grating 140 is located (e.g., through the second (top or front) surface 114 of the plate light guide 110). Further, the diffraction grating 140 is configured to diffractively couple out the portion of the guided light 104 as a coupled-out light beam 106.

The coupled-out light beam 106 is directed away from the light guide surface at a predetermined principal angular direction, according to various embodiments. In particular, the coupled-out portion of the guided light 104 is diffractively redirected away from the light guide surface by the plurality of diffraction gratings 140 as a plurality of light beams 106. As discussed above, each of the light beams 106 of the light beam plurality may have a different principal angular direction (e.g., as illustrated in FIGS. 2A-2B) and the light beam plurality may represent a light field, according to some embodiments (e.g., as further described below). According to other embodiments (not illustrated), each of the coupled-out light beams of the light beam plurality may have substantially the same principal angular direction and the light beam plurality may represent substantially unidirectional light, e.g., as opposed to the light field represented by the light beam plurality having light beams 106 with different principal angular directions.

Referring to FIGS. 2A-2B, according to various embodiments, the diffraction grating 140 comprises a plurality of diffractive features 142 that diffract light (i.e., provide diffraction). The diffraction is responsible for the diffractive coupling of the portion of the guided light 104 out of the plate light guide 110. For example, the diffraction grating 140 may include one or both of grooves in a surface of the plate light guide 110 and ridges protruding from the plate light guide surface that serve as the diffractive features 142. The grooves and ridges may be arranged parallel or substantially parallel to one another and, at least at some point, perpendicular to a propagation direction of the guided light 104 that is to be coupled out by the diffraction grating 140.

In some examples, the diffractive features 142 may be etched, milled or molded into the surface or applied on the surface of the plate light guide 110. As such, a material of the diffraction grating 140 may include a material of the plate light guide 110. As illustrated in FIG. 2A, for example, the diffraction gratings 140 comprise substantially parallel grooves formed in the surface of the plate light guide 110. Equivalently, the diffraction gratings 140 may comprise substantially parallel ridges that protrude from the plate light guide surface (not illustrated). In other examples (not illustrated), the diffraction gratings 140 may be implemented in or as a film or layer applied or affixed to the surface of the plate light guide 110.

The plurality of diffraction gratings 140 may be arranged in a variety of configurations with respect to the plate light guide 110. For example, the plurality of diffraction gratings 140 may be arranged in columns and rows across the light guide surface (e.g., as an array). In another example, a plurality of diffraction gratings 140 may be arranged in groups and the groups may be arranged in rows and columns. In yet another example, the plurality of diffraction gratings 140 may be distributed substantially randomly across the surface of the plate light guide 110.

According to some embodiments, the plurality of diffraction gratings 140 comprises a multibeam diffraction grating 140. For example, all or substantially all of the diffraction gratings 140 of the plurality may be multibeam diffraction gratings 140 (i.e., a plurality of multibeam diffraction gratings 140). The multibeam diffraction grating 140 is a diffraction grating 140 that is configured to couple out the portion of the guided light 104 as a plurality of light beams 106 (e.g., as illustrated in FIGS. 2A and 2B), having different principal angular directions that form a light field, according to various embodiments.

According to various examples, the multibeam diffraction grating 140 may comprise a chirped diffraction grating 140 (i.e., a chirped multibeam diffraction grating). By definition, the ‘chirped’ diffraction grating 140 is a diffraction grating exhibiting or having a diffraction spacing of the diffractive features that varies across an extent or length of the chirped diffraction grating 140. Further herein, the varying diffraction spacing is defined as a ‘chirp’. As a result, the guided light 104 that is diffractively coupled out of the plate light guide 110 exits or is emitted from the chirped diffraction grating 140 as the plurality of light beams 106 at different diffraction angles corresponding to different points of origin across the chirped multibeam diffraction grating 140. By virtue of a predefined chirp, the chirped diffraction grating 140 is responsible for respective predetermined and different principal angular directions of the coupled-out light beams 106 of the light beam plurality. In some embodiments, the chirped diffraction grating 140 may have or exhibit a chirp that varies linearly with distance. As such, the chirped diffraction grating 140 may be referred to as a ‘linearly chirped’ diffraction grating.

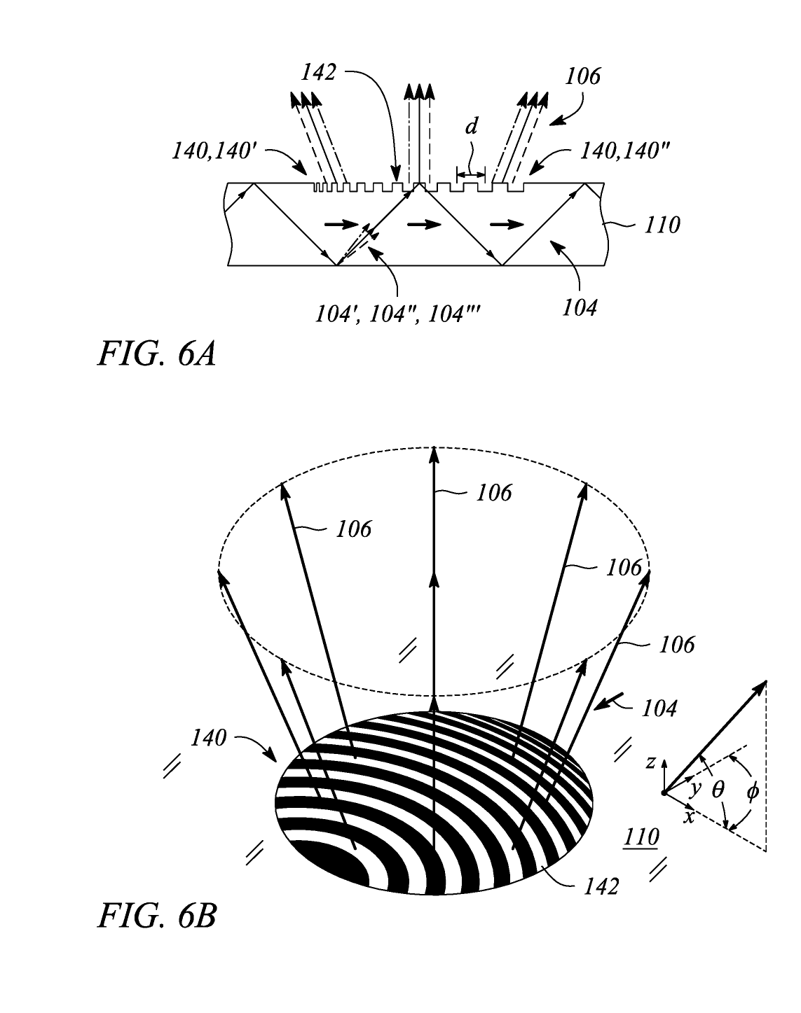

FIG. 6A illustrates a cross sectional view of a portion of a polychromatic grating-coupled backlight 100 including a multibeam diffraction grating 140 in an example, according to an embodiment consistent with the principles described herein. FIG. 6B illustrates a perspective view of the polychromatic grating-coupled backlight portion of FIG. 6A including the multibeam diffraction grating 140 in an example, according to an embodiment consistent with the principles described herein. The multibeam diffraction grating 140 illustrated in FIG. 6A comprises grooves in a surface of the plate light guide 110, by way of example and not limitation. For example, the multibeam diffraction grating 140 illustrated in FIG. 6A may represent one of the groove-based diffraction gratings 140 illustrated in FIG. 2A.

As illustrated in FIGS. 6A-6B (and also FIGS. 2A-2B by way of example and not limitation), the multibeam diffraction grating 140 is a chirped diffraction grating. In particular, as illustrated, the diffractive features 142 are closer together at a first end 140′ of the multibeam diffraction grating 140 than at a second end 140″. Further, the illustrated multibeam diffraction grating 140 comprise a linearly chirped diffraction grating having a diffractive spacing d of the diffractive features 142 that varies (increases) linearly from the first end 140′ to the second end 140″.

In some embodiments, the light beams 106 produced by diffractively coupling light out of the plate light guide 110 using the multibeam diffraction grating 140 may diverge (i.e., be diverging light beams 106) when the guided light 104 propagates in the plate light guide 110 in a direction from the first end 140′ of the multibeam diffraction grating 140 to the second end 140″ of the multibeam diffraction grating 140 (e.g., as illustrated in FIG. 6A). Alternatively, converging light beams 106 may be produced when the guided light 104 propagates in the reverse direction in the plate light guide 110, i.e., from the second end 140″ to the first end 140′ of the multibeam diffraction grating 140 (not illustrated).

In other embodiments (not illustrated), the chirped diffraction grating 140 may exhibit a non-linear chirp of the diffractive spacing d. Various non-linear chirps that may be used to realize the chirped diffraction grating 140 include, but are not limited to, an exponential chirp, a logarithmic chirp or a chirp that varies in another, substantially non-uniform or random but still monotonic manner. Non-monotonic chirps such as, but not limited to, a sinusoidal chirp or a triangle or sawtooth chirp, may also be employed. Combinations of any of these types of chirps may also be used.

As illustrated in FIG. 6B, the multibeam diffraction grating 140 includes diffractive features 142 (e.g., grooves or ridges) in, at or on a surface of the plate light guide 110 that are both chirped and curved (i.e., the multibeam diffraction grating 140 is a curved, chirped diffraction grating). The guided light 104 has an incident direction relative to the multibeam diffraction grating 140 and the plate light guide 110, as illustrated by a bold arrow labeled ‘104’ in FIGS. 6A-6B. Also illustrated is the plurality of coupled-out or emitted light beams 106 pointing away from the multibeam diffraction grating 140 at the surface of the plate light guide 110. The illustrated light beams 106 are emitted in a plurality of predetermined different principal angular directions. In particular, the predetermined different principal angular directions of the emitted light beams 106 are different in both azimuth and elevation (e.g., to form a light field), as illustrated. According to various examples, both the predefined chirp of the diffractive features 142 and the curve of the diffractive features 142 may be responsible for a respective plurality of predetermined different principal angular directions of the emitted light beams 106.

For example, due to the curve, the diffractive features 142 within the multibeam diffraction grating 140 may have varying orientations relative to an incident direction of the guided light 104 guided in the plate light guide 110. In particular, an orientation of the diffractive features 142 at a first point or location within the multibeam diffraction grating 140 may differ from an orientation of the diffractive features 142 at another point or location relative to the guided light beam incident direction. With respect to the coupled-out or emitted light beam 106, an azimuthal component ϕ of the principal angular direction {θ, ϕ} of the light beam 106 may be determined by or correspond to the azimuthal orientation angle ϕ_{ƒ} of the diffractive features 142 at a point of origin of the light beam 106 (i.e., at a point where the guided light 104 is coupled out), according to some embodiments. As such, the varying orientations of the diffractive features 142 within the multibeam diffraction grating 140 produce different light beams 106 having different principal angular directions {θ, ϕ}, at least in terms of their respective azimuthal components ϕ.

Thus, at different points along the curve of the diffractive features 142, an ‘underlying diffraction grating’ of the multibeam diffraction grating 140 associated with the curved diffractive features 142 has different azimuthal orientation angles ϕ_{ƒ}. By ‘underlying diffraction grating’, it is meant a diffraction grating of a plurality of non-curved diffraction gratings that in superposition yields the curved diffractive features of the multibeam diffraction grating 140. At a given point along the curved diffractive features 142, the curve has a particular azimuthal orientation angle ϕ_{ƒ} that generally differs from the azimuthal orientation angle ϕ_{ƒ} another point along the curved diffractive features 142. Further, the particular azimuthal orientation angle ϕ_{ƒ} results in a corresponding azimuthal component ϕ of a principal angular direction {θ, ϕ} of a light beam 106 emitted from the given point. In some examples, the curve of the diffractive features 142 (e.g., grooves, ridges, etc.) may represent a section of a circle. The circle may be coplanar with the light guide surface. In other examples, the curve may represent a section of an ellipse or another curved shape, e.g., that is coplanar with the light guide surface.

In other examples, the multibeam diffraction grating 140 may include diffractive features 142 that are ‘piecewise’ curved. In particular, while the diffractive feature 142 may not describe a substantially smooth or continuous curve per se, at different points along the diffractive feature 142 within the multibeam diffraction grating 140, the diffractive feature 142 still may be oriented at different angles with respect to the incident direction of the guided light 104. For example, the diffractive feature 142 may be a groove including a plurality of substantially straight segments, each segment having a different orientation than an adjacent segment. Together, the different angles of the segments may approximate a curve (e.g., a segment of a circle), according to various embodiments. In yet other examples, the diffractive features 142 may merely have different orientations relative to the incident direction of the guided light at different locations within the multibeam diffraction grating 140 without approximating a particular curve (e.g., a circle or an ellipse).

As discussed above, the guided light 104 comprises a plurality of light beams of different colors, wherein the different color light beams are configured to be guided within the plate light guide 110 at different, color-specific, non-zero propagation angles. For example, a light beam of red guided light 104 may be coupled into and propagate within the plate light guide 110 at a first non-zero propagation angle; a light beam of green guided light 104 may be coupled into and propagate within the plate light guide 110 at a second non-zero propagation angle; and a light beam of blue guided light 104 may be coupled into and propagate within the plate light guide 110 at a third non-zero propagation angle. According to various embodiments, the respective first, second and third non-zero propagation angles are different from one another. Moreover, the different color-specific, non-zero propagation angles of the plurality of different color light beams of the guided light 104 that is provided by the grating coupler 130 may be configured to mitigate color dispersion of the respective different colors of light by the diffraction grating 140 and, in particular, the multibeam diffraction grating 140. That is, the different color-specific, non-zero propagation angles of the different color light beams plurality may be chosen to substantially correct or compensate for differences in the diffractive coupling out provided by the diffraction grating 140 (or multibeam diffraction grating 140) as a function of color. Thus, light of each color of a plurality of different colors within the polychromatic light 102 (e.g., red light, green light, and blue light) may be diffractively coupled out of the plate light guide 110 at substantially similar principal angular directions to one another as the coupled-out light beams 106. The result of the different color-specific, non-zero propagation angles of the guided light 104 is that, for a given principal angular direction, the diffraction grating 140 or multibeam diffraction grating 140 may provide a plurality of coupled out light beams 106 that includes each of the different colors of light in the polychromatic light 102. Without the collimated polychromatic light 102 and the grating coupler 130, as described herein, the different color light beams would be coupled out of the plate light guide 110 by the multibeam diffraction grating 140 at respective different principal angular directions to one another and may cause or exacerbate color dispersion in a view direction.

FIG. 6A illustrates coupled-out light beams 106 of different colors depicted using different line types, for purposes of illustration. The coupled-out light beams 106 of different colors are parallel with one another in each of several different principal angular directions. The resulting parallel relationship of the different color coupled-out light beams 106 in the different principal angular directions is provided in part by the different color-specific, non-zero propagation angles of the guided light 104 of the respective different colors (also illustrated using different line types) in the plate light guide 110. Moreover, as a result of the parallel relationship, the coupled-out light beams 106 may combine in some embodiments to represent substantially white light (or at least polychromatic light), according to some embodiments. Note that, in FIG. 6A as well as in FIGS. 2A and 2B, only a central light beam is illustrated for ease of illustration of the guided light 104 with an understanding that the central light beam generally represents a plurality of different color light beams of the guided light 104 (e.g., light beams 104′, 104″, and 104′″) having different color-specific, non-zero propagation angles (e.g., the angles γ′, γ″, γ′″, illustrated in FIG. 2C).

According to some embodiments of the principles described herein, an electronic display is provided. In some embodiments, the electronic display is a two-dimensional (2D) electronic display. In other embodiments, the electronic display is a three-dimensional (3D), or equivalently ‘multiview,’ electronic display. The 2D electronic display is configured to emit modulated light beams as pixels to display information (e.g., 2D images). The 3D electronic display is configured to emit modulated light beams having different directions as ‘multiview’ or directional pixels configured to display 3D information (e.g., 3D images). In some embodiments, the 3D electronic display is an autostereoscopic or glasses-free 3D electronic display. In particular, different ones of the modulated, differently directed, light beams may correspond to view directions of different ‘views’ (e.g., multiviews) associated with the 3D electronic display. The different views may provide a ‘glasses free’ (e.g., autostereoscopic, multiview, etc.) representation of information being displayed by the 3D electronic display, for example.

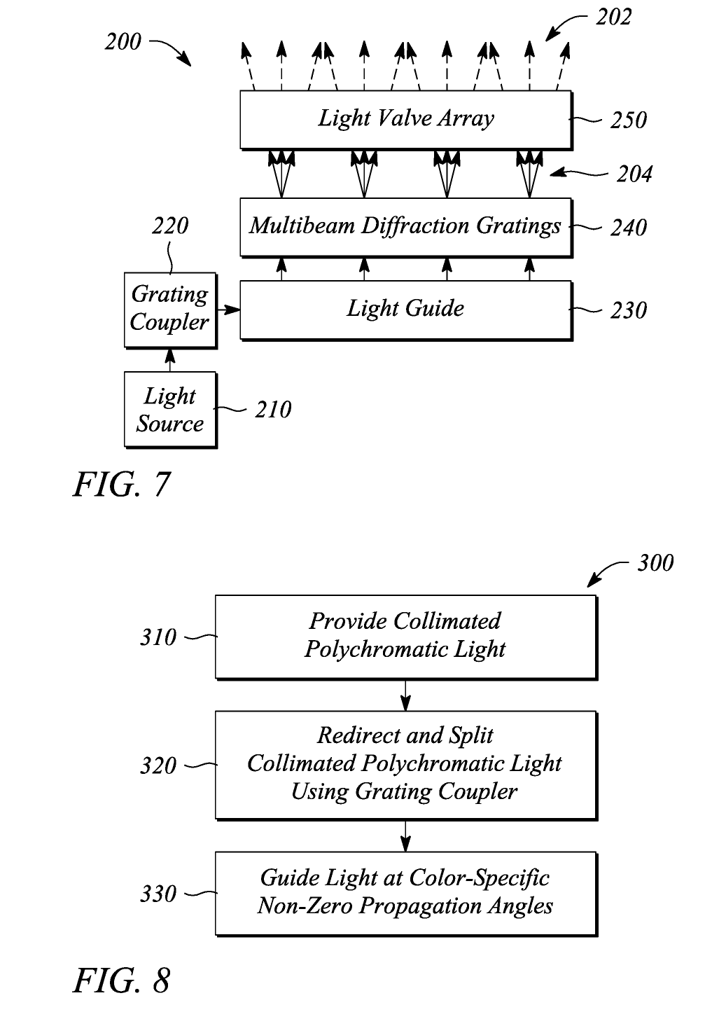

FIG. 7 illustrates a block diagram of an electronic display 200 in an example, according to an embodiment consistent with the principles described herein. In particular, the electronic display 200 may be a 3D electronic display 200, according to some embodiments. The electronic display 200 illustrated in FIG. 7 is configured to emit modulated light beams 202. As a 3D electronic display 200, the light beams may be emitted in different principal angular directions representing 3D or multiview pixels corresponding to the different views (i.e., directed in different view directions) of the 3D electronic display 200. The modulated light beams 202 are illustrated as diverging (e.g., as opposed to converging) in FIG. 7, by way of example and not limitation. In some embodiments, the light beams 202 may further represent different colors and the electronic display 200 may be a color electronic display.

The electronic display 200 illustrated in FIG. 7 comprises a light source 210. The light source 210 is configured to provide collimated polychromatic light. According to some embodiments, the light source 210 may be substantially similar to the light source 120 described above with respect to the polychromatic grating-coupled backlight 100. In particular, according to some embodiments, the light source 210 may comprise an optical emitter configured to provide the polychromatic light and a collimator configured to collimate the polychromatic light. In some embodiments, the optical emitter comprises a plurality of optical emitters, each optical emitter of the emitter plurality being configured to provide a different color of light of the polychromatic light. For example, the plurality of optical emitters comprises a first optical emitter comprising a red light-emitting diode (LED) configured to provide red light, a second optical emitter comprising a green LED configured to provide green light, and a third optical emitter comprising a blue LED configured to provide blue light. Other embodiments, the plurality of optical emitters may comprise phosphors illuminated by an illumination source (e.g., an ultraviolet light source or a blue light source). In yet other embodiments, the optical emitter may comprise a white light source, e.g., a white light emitting diode (LED).

The electronic display 200 further comprises a grating coupler 220. The grating coupler 220 is configured to diffractively split and redirect the collimated polychromatic light into a plurality of light beams. Each light beam of the light beam plurality represents a different color of light. According to some embodiments, the grating coupler 220 is substantially similar to the grating coupler 130 of the polychromatic grating-coupled backlight 100, described above. In particular, the grating coupler 220 comprises a diffraction grating configured to diffract the collimated polychromatic light from the light source 210. Light diffraction of the collimated polychromatic light, in turn, results in the diffractive splitting and redirecting of the polychromatic light at different angles (e.g., the plurality of light beams) corresponding to the different colors. In some embodiments, the grating coupler 220 comprises one or both of a transmission mode diffraction grating and a reflection mode diffraction grating, i.e., the grating coupler 220 is one or both of a transmissive grating coupler and a reflective grating coupler.

The electronic display 200 illustrated in FIG. 7 further comprises a light guide 230 configured to receive and guide the plurality of different color light beams. In particular, the different color light beams are received and guided by the light guide 230 at different color-specific, non-zero propagation angles as guided light within the light guide 230. Moreover, the different color-specific, non-zero propagation angles result from the diffractive splitting and redirection of the polychromatic light by the grating coupler 220.

According to some embodiments, the light guide 230 may be substantially similar to the plate light guide 110 described above with respect to the polychromatic grating-coupled backlight 100. For example, the light guide 230 may be a slab optical waveguide comprising a planar sheet of dielectric material configured to guide light by total internal reflection. In other embodiments, the light guide 230 may comprise a strip light guide. For example, the light guide 230 may comprise a plurality of substantially parallel strip light guides arranged adjacent to one another to approximate a plate light guide and thus be considered a form of a ‘plate’ light guide, by definition herein. However, the adjacent strip light guides of this form of plate light guide may confine light within the respective strip light guides and substantially prevent leakage into adjacent strip light guides (i.e., unlike a substantially continuous slab of material of the ‘true’ plate light guide), for example.

The electronic display 200 further comprises a diffraction grating 240 configured to diffractively couple out a portion of the guided light as a coupled-out light beam. In some embodiments (e.g., when the electronic display 200 is a 3D electronic display 200), the diffraction grating 240 may comprise a multibeam diffraction grating 240, as illustrated in FIG. 7 by way of example. The multibeam diffraction grating 240 may be located in, on or at a surface of the light guide 230, for example. According to various embodiments, the multibeam diffraction grating 240 is configured to diffractively couple out a portion of the plurality of different color light beams guided within the light guide 230 as a plurality of coupled-out light beams 204 having different principal angular directions representing or corresponding to different views of the 3D electronic display 200. In each principal angular direction, the coupled-out light beams 204 comprise substantially parallel beams of different color light. In some embodiments, the diffraction grating and more particularly the multibeam diffraction grating 240 may be substantially similar to the diffraction grating 140 and the multibeam diffraction grating 140 of the polychromatic grating-coupled backlight 100, described above.

For example, the multibeam diffraction grating 240 may include a chirped diffraction grating. Further the multibeam diffraction grating 240 may be a member of an array of multibeam diffraction gratings. In some embodiments, diffractive features (e.g., grooves, ridges, etc.) of the multibeam diffraction grating 240 are curved diffractive features. For example, the curved diffractive features may include ridges or grooves that are curved (i.e., continuously curved or piece-wise curved) and spacings between the curved diffractive features that vary as a function of distance across the multibeam diffraction grating 240. In some embodiments, the multibeam diffraction grating 240 may be a chirped diffraction grating having curved diffractive features.

Also illustrated in FIG. 7, the electronic display 200 further includes a light valve array 250. The light valve array 250 includes a plurality of light valves configured to modulate the coupled-out light beams 204 of the light beam plurality. In particular, the light valves of the light valve array 250 modulate the coupled-out light beams 204 to provide the modulated light beams 202 that are or represent pixels of the electronic display 200. The modulated light beams 202 comprise substantially parallel beams of different color light in each pixel representation. When the electronic display 200 is a multiview or 3D electronic display, the pixels may be multiview pixels, for example. Moreover, different ones of the modulated light beams 202 may correspond to different views of the 3D electronic display 200. As such, the modulated light beams 202 in each different view comprise substantially parallel beams of different color light. In various examples, different types of light valves in the light valve array 250 may be employed including, but not limited to, one or more of liquid crystal (LC) light valves, electrowetting light valves and electrophoretic light valves. Dashed lines are used in FIG. 7 to emphasize modulation of the light beams 202, by way of example.

According to some examples of the principles described herein, a method of polychromatic grating-coupled backlight operation is provided. In some embodiments, the method of polychromatic grating-coupled backlight operation may be used to provide backlighting to an electronic display and specifically to provide directional backlighting to a multiview or 3D electronic display. FIG. 8 illustrates a flow chart of a method 300 of polychromatic grating-coupled backlight operation in an example, according to an embodiment consistent with the principles described herein. As illustrated in FIG. 8, the method 300 of polychromatic grating-coupled backlight operation comprises providing 310 collimated polychromatic light using a light source. According to some embodiments, providing 310 collimated polychromatic light may employ a light source substantially similar to the light source 120 described above with respect to the polychromatic grating-coupled backlight 100. For example, a light source comprising a polychromatic optical emitter (e.g., a white light source or a plurality of different color optical emitters) and a collimator (e.g., a lens) may be employed to provide 310 the collimated polychromatic light. Further, providing 310 collimated polychromatic light may comprise generating polychromatic light using the polychromatic optical emitter and collimating the polychromatic light using a collimator, in some embodiments.

The method 300 of polychromatic grating-coupled backlight operation comprises redirecting and splitting 320 the collimated polychromatic light into a plurality of light beams, for example using a grating coupler. Each light beam of the light beam plurality produced by redirecting and splitting 320 represents a different respective color of the collimated polychromatic light. According to some embodiments, the grating coupler used in redirecting and splitting 320 is substantially similar to the grating coupler 130 of the polychromatic grating-coupled backlight 100, described above. In particular, the grating coupler may comprise one or both of a transmissive mode diffraction grating and a reflection mode diffraction grating, according to some embodiments.

The method 300 of polychromatic grating-coupled backlight operation further comprises guiding 330 the different color light beams of the plurality of light beams in a light guide at respective different color-specific, non-zero propagation angles as guided light. In some embodiments, the light guide may be substantially similar to the plate light guide 110 described above with respect to the polychromatic grating-coupled backlight 100. Further, the color-specific, non-zero propagation angles of the light beams are produced by diffractive redirection, e.g., in the grating coupler, as a result of redirection and splitting 320. As such, the different color-specific, non-zero propagation angles may be substantially similar to the different color-specific, non-zero propagation angles also described above.

In some embodiments (not illustrated), the method 300 of polychromatic grating-coupled backlight operation further comprises diffractively coupling out a portion of the guided light in the light guide, for example using a diffraction grating at a surface of the light guide. In some examples, the diffraction grating may be substantially similar to the diffraction grating of the polychromatic grating-coupled backlight 100, described above. For example, diffractively coupling out a portion of the guided light may produce a coupled-out light beam directed away from the light guide at a predetermined principal angular direction. Moreover, the coupled-out light beam may comprise substantially parallel beams of different color light in the predetermined principal angular direction as a result of the different color-specific, non-zero propagation angles of the guided light in the light guide.

In some embodiments, the diffraction grating used in diffractively coupling out a portion of the guided light is a multibeam diffraction grating. As such, in some embodiments, diffractively coupling out a portion of the guided light may use a multibeam diffraction grating to produce a plurality of coupled-out light beams directed away from the light guide in a plurality of different principal angular directions corresponding to different respective view directions of different views of a three-dimensional (3D) electronic display. In each different principal angular direction or different respective view direction, the coupled-out light beams comprise substantially parallel beams of different color light, for example as a result of the different color-specific, non-zero propagation angles of the guided light in the light guide. In some embodiments, the multibeam diffraction grating may be substantially similar to the multibeam diffraction grating 140 described above with respect to the polychromatic grating-coupled backlight 100. For example, the multibeam diffraction grating may be a linearly chirped diffraction grating comprising one of curved grooves and curved ridges that are spaced apart from one another to provide the diffractive coupling.

In some embodiments (not illustrated), the method 300 of polychromatic grating-coupled backlight operation further comprises modulating the plurality of coupled-out light beams, for example using a plurality of light valves. The modulated light beams comprise substantially parallel beams of different color light in a predetermined principal angular direction. In some embodiments, the plurality of light valves may be substantially similar to the light valve array 250 described above with respect to the electronic display 200. For example, the light valves may include, but are not limited to, one or more of liquid crystal (LC) light valves, electrowetting light valves and electrophoretic light valves. In some examples, the light valve array may be part of a multiview or 3D electronic display 200 having different view directions representing pixels of the 3D display, for example. The modulated, coupled-out light beams from the 3D electronic display according to this example comprise substantially parallel beams of different color light in each different view direction or pixel.

Thus, there have been described examples of a polychromatic grating-coupled backlight, an electronic display and a method of polychromatic grating-coupled backlight operation that employ a grating coupler to diffractively split and redirect collimated light coupled into a light guide. It should be understood that the above-described examples are merely illustrative of some of the many specific examples and embodiments that represent the principles described herein. Clearly, those skilled in the art can readily devise numerous other arrangements without departing from the scope as defined by the following claims.

What is claimed is:

1. A polychromatic grating-coupled backlight comprising:
a plate light guide configured to guide light;
a light source comprising an optical emitter configured to provide polychromatic light and a collimator configured to collimate the polychromatic light; and
a grating coupler configured to diffractively split and redirect the collimated polychromatic light into a plurality of light beams, each light beam of the plurality representing a respective different color of the polychromatic light and being configured to propagate within the plate light guide as guided light at a color-specific, non-zero propagation angle corresponding to a respective different color of polychromatic light.

2. The polychromatic grating-coupled backlight of claim 1, wherein the polychromatic light comprises a different two or more colors of red light, green light and blue light each having a respective wavelength, and wherein a color-specific, non-zero propagation angle of a respective color of the guided light with a longer wavelength is smaller than the color-specific, non-zero propagation angle of a respective color of the guided light with a shorter wavelength.

3. The polychromatic grating-coupled backlight of claim 1, wherein the optical emitter comprises a light emitting diode configured to provide white light.

4. The polychromatic grating-coupled backlight of claim 1, wherein the optical emitter comprises a first light emitting diode (LED) configured to provide red light, a second LED configured to provide green light, and a third LED configured to provide blue light, a combination of the red light, the green light and the blue light being configured to provide white light.

5. The polychromatic grating-coupled backlight of claim 1, wherein the optical emitter comprises an illumination source configured to provide illumination and a plurality of phosphors configured to luminesce in response to the illumination from the illumination source, each phosphor of the phosphor plurality having a luminescence corresponding to a different color of the polychromatic light.

6. The polychromatic grating-coupled backlight of claim 1, wherein the light source collimator comprises a collimating lens.

7. The polychromatic grating-coupled backlight of claim 1, wherein the grating coupler is a transmissive grating coupler comprising a transmission mode diffraction grating.

8. The polychromatic grating-coupled backlight of claim 1, wherein the grating coupler is a reflective grating coupler comprising a reflection mode diffraction grating.

9. The polychromatic grating-coupled backlight of claim 8, wherein the reflective grating coupler further comprises a layer of reflective material configured to enhance reflection of the collimated polychromatic light by the reflection mode diffraction grating.

10. The polychromatic grating-coupled backlight of claim 1, further comprising a diffraction grating at a surface of the plate light guide, the diffraction grating being configured to diffractively couple out a portion of the guided light as a coupled-out light beam having a predetermined principal angular direction emitted from the plate light guide surface, the coupled-out portion comprising the different colors of polychromatic light.

11. The polychromatic grating-coupled backlight of claim 1, further comprising a multibeam diffraction grating at a surface of the plate light guide, the multibeam diffraction grating being configured to diffractively couple out a portion of the guided light as a plurality of coupled-out light beams emitted from the plate light guide surface, a coupled-out light beam of the coupled-out light beam plurality having a principal angular direction different from principal angular directions of other coupled-out light beams of the coupled-out light beam plurality.

12. The polychromatic grating-coupled backlight of claim 11, wherein the multibeam diffraction grating comprises a linearly chirped diffraction grating.

13. A three-dimensional (3D) electronic display comprising the polychromatic grating-coupled backlight of claim 11, the 3D electronic display further comprising:
a light valve to modulate a coupled-out light beam of the coupled-out light beam plurality, the light valve being adjacent to the multibeam diffraction grating,
wherein the principal angular direction of the coupled-out light beam corresponds to a view direction of the 3D electronic display, the modulated light beam representing a pixel of the 3D electronic display in the view direction, the modulated light beam in the view direction comprising each of the respective different colors in the polychromatic light.

14. The polychromatic grating-coupled backlight of claim 11, wherein the color-specific, non-zero propagation angles of the plurality of light beams of the guided light are configured to mitigate color dispersion of the respective different colors of light by the multibeam diffraction grating.

15. An electronic display comprising:
a light source configured to provide collimated polychromatic light;
a grating coupler configured to diffractively split and redirect the collimated polychromatic light into a plurality of light beams, each light beam of the light beam plurality representing a different color of light;
a light guide configured to receive and guide the plurality of light beams of different colors at corresponding different color-specific, non-zero propagation angles as guided light within the light guide;
a diffraction grating configured to diffractively couple out a portion of the guided light as a coupled-out light beam comprising the different colors of light at a predetermined principal angular direction; and
a light valve array configured to modulate the coupled-out light beam, the modulated coupled-out light beam at the predetermined principal angular direction representing a pixel of the electronic display having the different colors of light.

16. The electronic display of claim 15, wherein the light source comprises an optical emitter configured to provide the polychromatic light and a collimator configured to collimate the polychromatic light.

17. The electronic display of claim 16, wherein the optical emitter comprises a plurality of optical emitters, each optical emitter of the emitter plurality being configured to provide a different color of light of the polychromatic light.

18. The electronic display of claim 16, wherein the optical emitter comprises a plurality of optical emitters, the plurality of optical emitters comprises a first optical emitter comprising a red light-emitting diode (LED) configured to provide red light, a second optical emitter comprising a green LED configured to provide green light, and a third optical emitter comprising a blue LED configured to provide blue light.

19. The electronic display of claim 15, wherein the grating coupler comprises one or both of a transmission mode diffraction grating and a reflection mode diffraction grating.

20. The electronic display of claim 15, wherein the diffraction grating comprises a multibeam diffraction grating, the diffractively coupled-out portion of the guided light from the multibeam diffraction grating comprising a plurality of coupled-out light beams emitted from a surface of the light guide, each coupled-out light beam of the coupled-out light beam plurality having a different principal angular direction from principal angular directions of other coupled-out light beams of the coupled-out light beam plurality, each coupled-out light beam in a respective different principal angular direction comprising substantially parallel beams of the different colors of light.

21. The electronic display of claim 20, wherein the electronic display is a three-dimensional (3D) electronic display, the different principal angular directions of the coupled-out light beams corresponding to different respective view directions of different 3D views of the 3D electronic display.

22. A method of polychromatic grating-coupled backlight operation, the method comprising:
providing collimated polychromatic light using a light source;
splitting and redirecting the collimated polychromatic light into a plurality of light beams using a grating coupler, each light beam of the plurality representing a different respective color of the collimated polychromatic light; and
guiding each light beam of the plurality in a light guide at a corresponding color-specific, non-zero propagation angle of the respective color as guided light.

23. The method of polychromatic grating-coupled backlight operation of claim 22, wherein providing collimated polychromatic light using a light source comprises:
generating polychromatic light using a polychromatic optical emitter; and
collimating the polychromatic light using a collimator.

24. The method of polychromatic grating-coupled backlight operation of claim 22, wherein the grating coupler comprises one or both of a transmissive mode diffraction grating and a reflection mode diffraction grating.

25. The method of polychromatic grating-coupled backlight operation of claim 22, further comprising:
diffractively coupling out a portion of the guided light using a diffraction grating at a surface of the light guide to produce a coupled-out light beam directed away from the light guide at a predetermined principal angular direction; and
modulating the coupled-out light beam using a light valve,
wherein the modulated, coupled-out light beam represents a pixel of an electronic display and comprises each color of the collimated polychromatic light.

26. The method of polychromatic grating-coupled backlight operation of claim 22, further comprising:
diffractively coupling out a portion of the guided light using a multibeam diffraction grating to produce a plurality of coupled-out light beams directed away from the light guide in a plurality of different principal angular directions corresponding to different respective view directions of different views of a three-dimensional (3D) electronic display, the coupled-out light beams in each different principal angular direction comprising each color the collimated polychromatic light; and
modulating the plurality of coupled-out light beams using a plurality of light valves,
wherein modulated light beams from the coupled-out light beam plurality form pixels corresponding to the different views of the 3D electronic display.

27. The method of polychromatic grating-coupled backlight operation of claim 26, wherein the multibeam diffraction grating is a linearly chirped diffraction grating comprising one of curved grooves and curved ridges that are spaced apart from one another.
